(19) United States
(12) Patent Application Publication
(10) Pub. No.: US 2002/0129346 A1
(43) Pub. Date: Sep. 12, 2002

(54) Method and apparatus for identifying software components using object relationships and object usages in use cases

(76) Inventors: Woo-Jin Lee, Taejon (KR); Min-Jeong Kim, Yongin-shi (KR); Gyu-Sang Shin, Taejon (KR)

Correspondence Address: JACOBSON, PRICE, HOLMAN & STERN, PROFESSIONAL LIMITED LIABILITY COMPANY, 400 Seventh Street, N.W., Washington`, DC, 20004, US

(21) Appl. No.: 09/835,528

(22) Filed: Apr. 17, 2001

(30) Foreign Application Priority Data
Dec. 14, 2000 (KR) 2000-76642

(51) Int. Cl. G06F 9/44

(52) U.S. Cl. 717/163

(57) ABSTRACT

An apparatus of identifying software components includes a user interface unit for obtaining object dependency and object usages information from a user; a unit of defining dependency weights for calculating weights of inter-object dependency based on the object dependency and the usages information; a unit of generating an object dependency network for representing the degrees of object importance and inter-object dependency by using the dependency weights; and a unit of identifying software components for controlling the component identification process by using the object dependency network and the threshold values inputted by a user.

### FIELD OF THE INVENTION

The present invention relates to a method and an apparatus for identifying software components using object relationships in the object model and object usages in use cases and relates to computer readable recording media storing a program to implement the inventive technique. More particularly, the invention relates to an apparatus and a method for generating an object dependency network, calculating dependency weights of inter-object relationships, and clustering closely related objects into components.

### DESCRIPTION OF THE PRIOR ART

A component based software development (CBSD) methodology was introduced to solve problems within the object-oriented methodology but basically includes the object-oriented concept.

FIG. 1 is a flow chart illustrating a general CBSD process.

First, domain modeling processes are carried out by unified modeling language (UML) modeling techniques for clearly describing the characteristics of systems in a target domain at step 101, and then, component units of independency and high reusability are identified at step 102.

Next, a component diagram is used for describing dependency 103 between provided interfaces, which are serviced by a component, and other components. By preserving the interfaces of the components, it is possible to perform independent development of each component. That is, a component can be independently designed and implemented in parallel with other components.

Meanwhile, one of the core parts of CBSD is a component identification process. In the component identification process, on the basis of domain characteristics and domain information, the parts which satisfy such component requirements as the reusability and the independency and so on are grouped as component candidates. However, domain information has lots of non-measurable properties. Criteria of the reusability and the independency are not clear. Therefore, until now, the component identification process relies on intuitions and experiences of domain exports.

There have been some approaches identifying software components. First, on the basis of an object relationship appeared in an object model, closely related objects are clustered into a component. Second, by considering control flows shown in a sequence diagram, a single thread of operations is identified as a component. Third, a subsystem identified during functional decomposition is considered as a component.

Most of above approaches focus on a single viewpoint such as an object viewpoint, a control thread viewpoint or an architecture viewpoint. Moreover, their criteria and procedures for identifying components are obscure. Therefore, although several users apply the same approach to the same domain, the results may appear in various patterns according to users.

### SUMMARY OF THE INVENTION

It is, therefore, an objective of the present invention to provide a method and an apparatus for identifying software components using object relationships in object model and object usages in use cases and to provide recording media using thereof.

That is, an objective of the present invention is to provide a method for generating an object dependency network by using object relationships extracted from the object model which are described in an object-oriented domain modeling process and by using object usage information extracted from sequence diagrams or inputted by users for each use case, and to provide an apparatus and a method of identifying software components for clustering closely related objects by considering inter-object dependency weights on the above object dependency network, and to provide computer-readable record media storing program instructions for performing the inventive method.

In accordance with an aspect of the present invention, there is provided an apparatus for identifying software components, comprising: a user interface unit for obtaining object dependency and object usages information from a user; a unit of defining dependency weights for calculating weights of inter-object dependency based on the object dependency and the usages information; a unit of generating an object dependency network for representing degrees of object importance and inter-object dependency by using the dependency weights; and a unit of identifying software components for controlling the component identification process by using the object dependency network and the threshold values inputted by a user.

In accordance with another aspect of the present invention, there is provided a method for identifying software components, comprising the steps of: a) generating a use case & object dependency graph by using an object model and object usages information; b) calculating a weight of each inter-object dependency and calculating a weight of object importance for each object by accumulating the dependency weights of connected objects; c) determining seed objects, each of which has a greater importance value than a predetermined threshold and assigning each of the seed objects to a component; and d) performing a navigation to an non-navigated object in order to add the non-navigated object to the component, wherein an inter-object dependency value of the non-navigated object is larger than the predetermined threshold.

In accordance with further another aspect of the present invention, there is provided computer readable recording media storing instructions for executing a component identification method, which can be applied to an apparatus of identifying software component having a mass-storage processor, the component identification method comprising the steps of: a) generating a use case & object dependency graph by using an object model and object usages information; b) calculating a weight of each inter-object dependency and calculating a weight of object importance for each object by accumulating the dependency weights of connected objects; c) determining seed objects, each of which has a greater importance value than a predetermined threshold and assigning each of the seed objects to a component; and d) performing a navigation to an non-navigated object in order to add the non-navigated object to the component, wherein an inter-object dependency value of the non-navigated object is larger than the predetermined threshold.

### BRIEF DESCRIPTION OF THE DRAWINGS

The above and other objectives and features of the present invention will become apparent from the following description of the preferred embodiments given in conjunction with the accompanying drawings, in which:

FIG. 1 is a flow chart Illustrating a general component based software development process;

FIG. 2 is a diagram showing a use case & object dependency graph in accordance with a first embodiment of the present invention;

FIG. 3 is a diagram showing an object dependency network in accordance with a second embodiment of the present invention;

FIG. 4 is a block diagram showing an apparatus of identifying software components in accordance with a third embodiment of the present invention; and

FIG. 5 is a flow chart showing a method of identifying software components in accordance with a fourth embodiment of the present invention.

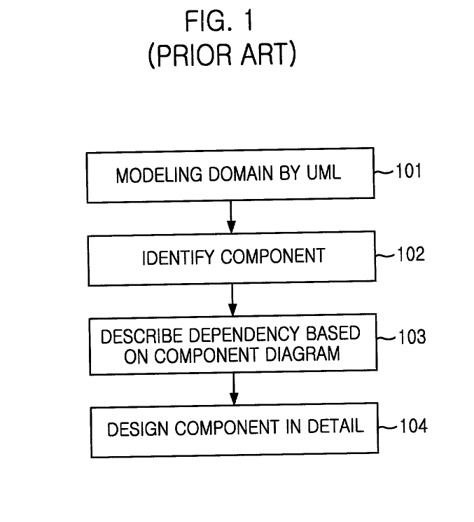

### DETAILED DESCRIPTION OF THE PREFERRED EMBODIMENTS

Hereinafter, preferred embodiments of the present invention will be described in detail with reference to the accompanying drawings.

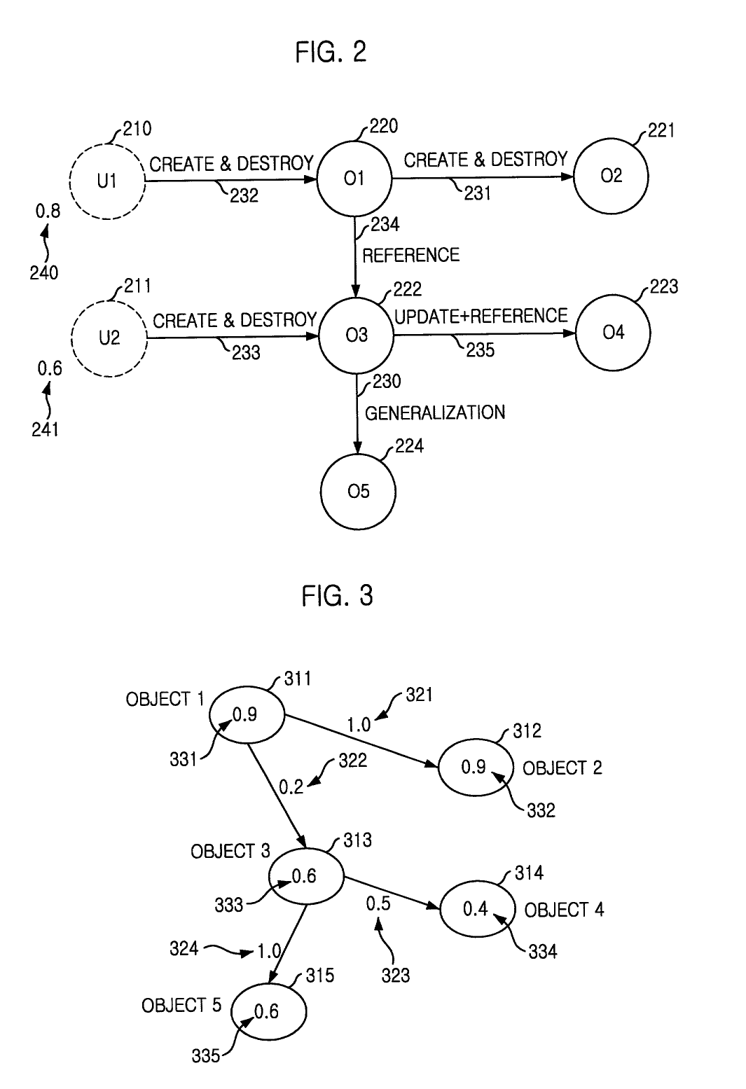

FIG. 2 is a diagram showing a use case & object dependency graph in accordance with a first embodiment of the present invention.

As described in FIG. 2, objects 220 to 224 and use cases 210 and 211 are denoted as nodes. Dependency relationships between objects or between use cases and objects are described by seven (7) dependency keywords as following; generalization, decomposition, create&destroy, create, destroy, update, reference.

The use cases 210 and 211 and the objects 220 to 224 are described as nodes in the shapes of dotted circles and lined circles. The dependencies between the nodes are divided into a structural relationship such as a generalization 230 and accumulated object usages information such as create & destroy 231 to 233 and update+reference 235, which are obtained by adding all usages of the corresponding object in all use cases. Further, real number values 240 and 241 appeared beside of the use case nodes, which represent the weight values of the use cases and ranges from 0.1 to 1.0, denote an importance degree of each use case.

FIG. 3 is a diagram showing an object dependency network in accordance with a second embodiment of the present invention. The object dependency network includes object nodes and dependencies between objects, which are denoted as dependency degrees (DD) and importance degree (ID) for each object without including use case nodes.

As described in FIG. 3, dependency degrees 321 to 324 among objects 311 to 315 have real values ranged from 0.0 to 1.0, which are calculated by using weights of use cases, inter-object structural relationships and object usages information, shown in the use case & object dependency graph.

An example of a weight-mapping table, which changes a dependency type to a dependency value ranged from 0.1 to 1.0, is shown in Table 1.

TABLE 1

| Dependency Type (DT) | Weight (DT) |
|---|---|
| Aggregation | 1.0 |
| Decomposition | 1.0 |
| Create/Destroy | 0.9 |
| Create | 0.7 |
| Destroy | 0.6 |
| Update | 0.5 |
| Reference | 0.3 |

Each value of DD between objects can be obtained by equation (1) as following. DD is obtained by summarizing each object dependency weight multiplied by the weight of corresponding use case, where an object dependency is composed of a bag of dependency types.

$${\sum }_{i = 1}^{n} W ( U C i ) * W e i g h t ( D T ) \qquad ( 1 )$$

Weight values 331 to 335, which are described in the objects 311 to 315 denoted as circular, show the ID of the objects 311 to 315.

The ID value of the object is calculated by adding DDs, which are described in incoming arcs to the objects in the use case & object dependency graph. That is, in order to estimate an importance degree of each object, all dependency weights of connected objects are accumulated.

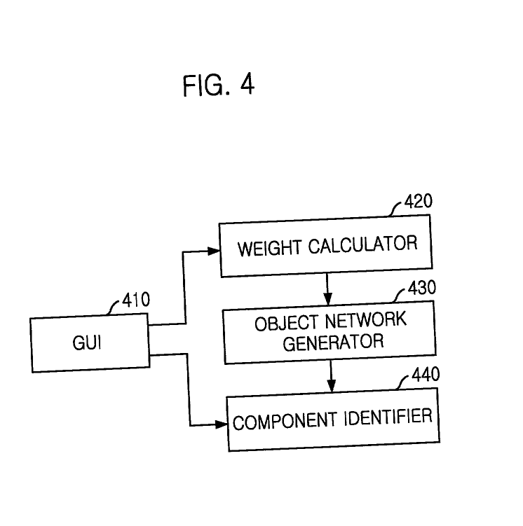

FIG. 4 is a block diagram showing an apparatus of identifying software components in accordance with a third embodiment of the present invention.

As described in FIG. 4, the component identification apparatus according to the present invention includes a graphical user interface (GUI) 410 which receives the inter-object information for the object model, the object usage information, which may be extracted from sequence diagrams or be inputted by users, a component identification threshold (CIT) and a seed object threshold (SOT) from a user. A weight calculator 420 calculates the inter-object dependency weight by using the received object dependency and object usages information from the GUI 410. An object network generator 430 generates an object dependency network by using the inter-object dependency weights calculated in the weight calculator 420. Based on CIT and SOT received from GUI, a component identifier 440 controls a component identification process by using the object dependency network, which is generated from the object network generator 430.

That is, the apparatus of identifying software components in accordance with the present invention calculates the inter-object dependency weight from the object model and the object usages information in the form of sequence diagrams and identifies software components by generating an object dependency network.

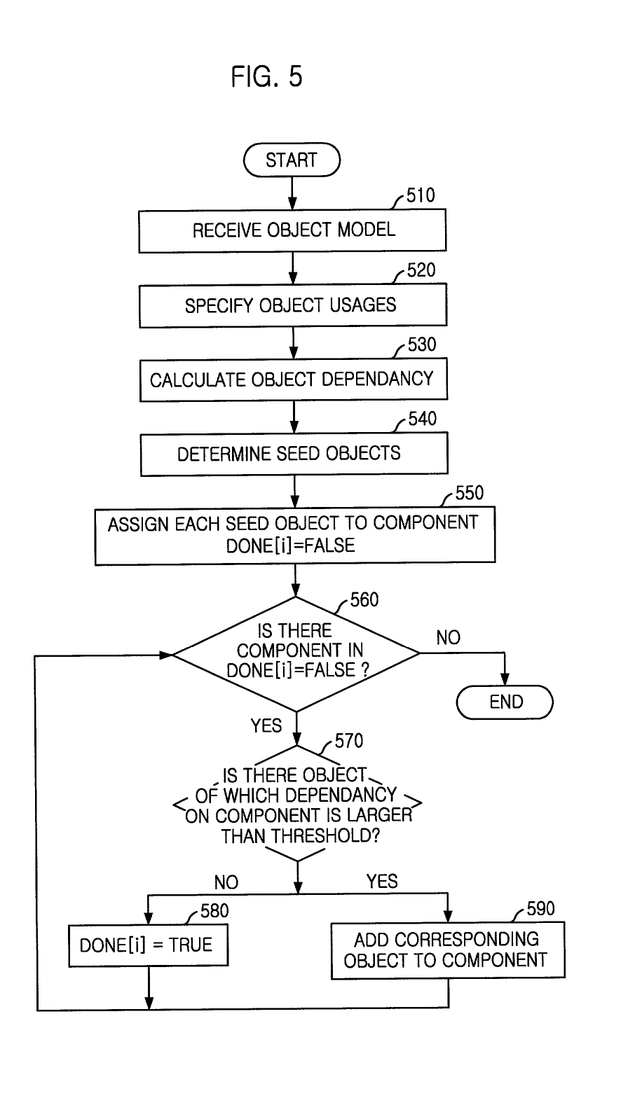

FIG. 5 is a flowchart showing a method of identifying software components in accordance with a preferred embodiment of the present invention.

First, object model information is received at step 510, where the object model information is divided into four relationships: association, decomposition, generalization and dependency. Among the four relationship types, the generalization and the decomposition show relatively tight and clean relationships among objects. About the association and dependency, on the other hand, it is difficult to measure the degree of importance in the object model. Therefore, the generalization and the decomposition are considered as structural dependency type and their weight values are assigned by referencing the weight-mapping table. The weights of the association and the decomposition are measured from use cases or sequence diagram information by considering object usages.

The specification of object usages described in FIG. 2 is performed on the use case & object dependency graph at step 520, which represents the dependency among objects or use cases and objects. The object usages information is extracted from sequence diagrams or inputted from users for each use case. The weight of use cases is also inputted from users.

Next, the weights of inter-object dependency, which is described in accumulated object usages form in the use case & object dependency graph, are calculated at step 530 by using the aforementioned weight calculation method. Subsequently, the ID of each object is calculated by adding the dependency weights of the connected objects. By calculating weights of DD and ID, an object dependency network can be obtained, as shown in FIG. 3.

On the object dependency network, an object that exceeds the predetermined SOT is settled to a seed object at step 540.

Then, the seed object is assigned to each of the components as a preparatory step of the component identification process at step 550. A condition flag, Done [i], is given to each of the components to determine whether further object navigation is possible or not. The condition flag, Done [i], is initialized as ‘false’ value, which means that object navigation is possible in the i^{th} component.

As a terminating condition of the identification algorithm, for each component, at step 560, it is determined whether there exists a component in which additional object navigation is possible, that is, (Done [i]=false) 560. As a result of performing the terminating condition, if all the components are not allowed to perform the navigation, then the process is terminated.

As a result of performing the terminating condition, if there exists a component which can carry out the navigation, at step 570, it is determined whether there exists a non-included object of which dependency (that is, the value of (DD of the corresponding arc)/(ID of the object) ) is larger than the CIT or not. If there exists such an object, the object is included into the corresponding component at step 590 and the process proceeds to the step 560. Otherwise, the Done [i] is set to “true” for preventing further navigation in the i^{th} component at step 580, then the process proceeds to the step 560.

The above-described method of the present invention can be implemented by a program and can be stored in media recording materials such as a CD-ROM, a RAM, a ROM, a floppy disk, a hard disk and a magnetic optical disk.

The present invention extracts object relationship information from an object model and extracts object usages information from sequence diagrams or from users, and provides a systematic process for identifying software components without relying on user's experience and intuition. Especially, comparing to conventional methods, the present invention provides a clean and systematic identification process.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for identifying software components, comprising:
a user interface means for obtaining object dependency and object usages information from a user;
a means of defining dependency weights for calculating weights of inter-object dependency based on the object dependency and the usages information;
a means of generating an object dependency network for representing degrees of object importance and inter-object dependency by using the dependency weights; and
a means of identifying software components for controlling the component identification process by using the object dependency network and the threshold values inputted by a user.

2. The apparatus of identifying software components as recited in claim 1, wherein the means of defining dependency weights considers not only the structural object dependency in the object model, but also the accumulated usages information among objects in the sequence diagrams of use cases in consideration of the importance weights of use cases.

3. The apparatus of identifying software components as recited in claim 1, wherein the means of generating the object dependency network represents dependency degrees (DD) among objects, which are calculated by using structural dependency and the object usages information, and the importance degrees (ID) of each objects, which are calculated by summarizing the dependency degrees of connected objects.

4. The apparatus of identifying software components as recited in claim 1, wherein the means of identifying software components performs a clustering for grouping highly related objects on the object dependency network by considering the degrees of the object importance and the object dependency.

5. A method for identifying software components, comprising the steps of:
a) generating a use case & object dependency graph by using an object model and object usages information;
b) calculating a weight of each inter-object dependency and calculating a weight of object importance for each object by accumulating the dependency weights of connected objects;
c) determining seed objects, each of which has a greater importance value than a predetermined threshold and assigning each of the seed objects to a component; and
d) performing a navigation process to a non-navigated object in order to add the non-navigated object to the component, wherein an inter-object dependency value of the non-navigated object is larger than the predetermined threshold.

6. The method as recited in claim 5, wherein the step d) includes the steps of:
d1) setting initial conditions of the components for the navigation of an object;
d2) determining whether there is a component of which an object can be navigated or not;
d3) if there is the component, determining whether a non-included object of which the dependency value on the component is greater than a predetermined threshold exists in the component or not, if not, terminating the navigation process; and
d4) if there exists the non-included object in the component, adding the non-included object into the component and going back to the step d2), if not, setting Done [i] to “true”, terminating the navigation process and going back to the step d2).

7. The method as recited in claim 5, wherein the step b) includes the steps of:
b) calculating a weight of each inter-object dependency and calculating a weight of object importance for each object by accumulating the dependency weights of connected objects;
b1) describing the dependency weights of inter-object dependency and the weights to object importance by positive real values with considering not only the structural object dependency in the object model, but also the accumulated usages information among objects in the sequence diagrams of use cases;
b2) calculating a weight of the object importance for each object based on the dependency weights of inter-object dependency.

8. The method as recited in claim 5, wherein the step d) includes the step of performing a clustering for grouping highly related objects on the object dependency network by considering the degrees of the object importance and the object dependency.

9. A computer readable recording medium storing instructions for executing a method for identifying software components, which can be applied to an apparatus of identifying software component having a mass-storage processor, the component identification method comprising the steps of:
a) generating a use case & object dependency graph by using an object model and object usages information;
b) calculating a weight of each inter-object dependency and calculating a weight of object importance for each object by accumulating the dependency weights of connected objects;
c) determining seed-objects, each of which has a greater importance value than a predetermined threshold and assigning each of the seed objects to a component; and
d) performing a navigation process to a non-navigated object in order to add the non-navigated object to the component, wherein an inter-object dependency value of the non-navigated object is larger than the predetermined threshold.
